(19) United States
(12) Patent Application Publication
(10) Pub. No.: US 2024/0272880 A1
(43) Pub. Date: Aug. 15, 2024

(54) USER INTERFACE AS A SERVICE ARCHITECTURE

(71) Applicant: Oracle International Corporation, Redwood Shores, CA (US)

(72) Inventors: Péter Ádám Ondrejka, Dunakeszi (HU); István Kiss, Budapest (HU); Vajk Fekete, Budapest (HU); Ádám Gém, Debrecen (HU); Lajos David, Derecske (HU); Tamas Radvanszki, Mountain View, CA (US); Yongran (Anthony) Huang, San Jose, CA (US); Yu Jun (Richard) Lam, Redwood Shores, CA (US); Robert Martijn Goris, Barcelona (ES); Kyle Ingvald Parent, San Mateo, CA (US)

(73) Assignee: Oracle International Corporation, Redwood Shores, CA (US)

(21) Appl. No.: 18/166,950

(22) Filed: Feb. 9, 2023

(51) Int. Cl. G06F 8/38

(52) U.S. Cl. CPC G06F 8/38

(57) ABSTRACT

Large applications may access data from a number of different computing environments. Each of these computing environments may provide user interface (UI) components that are tightly coupled with the backend services providing the data. When an application is loaded in one computing environment, the main UI and local UI components from that environment may be loaded during initialization. Additionally, UI components from other computing environments may be dynamically added to the main UI at runtime. These UI components may communicate through proxies that resolve cross-domain communication and pass secure user tokens to retrieve data from the corresponding backend services in the other computing environments for display by the UI components in the main UI. Thus, the user interface may seamlessly integrate UI components and associated data across different computing domains.

### BACKGROUND

Different software systems usually run in different and potentially segregated environments. Operating in different environments causes a number of problems when it comes to reusing parts of one system or integrating with another system. This is particularly true with user interfaces that operate in a local environment while accessing data or functionality at a backend that is hosted in other computing environments. Although traditionally some integration points between different systems already exist, such as web service interfaces or REST service endpoints, these solutions still fall short of a truly distributed yet integrated user interface environment. For example, systems in one computing environment may need to implement user interfaces to present data from a separate computing environment, which results in hard dependencies between the user interface and the data backend designed by different teams. For large, monolithic user interfaces, small changes to the underlying data in a distributed system may result in large changes to the user interface. User identities are often difficult to propagate between different systems. Therefore, improvements are needed in this area of technology.

### SUMMARY

In some embodiments, a framework may allow user interface components with their backend services and data to be reused while maintaining an ideal level of security, authentication, and communication. Instead of building a user interface as a microservice for a specific application, this framework allows user interface components to be designed specifically for the associated backend data. These components may then be reused across a number of different applications that all access the same backend data. This framework may include a user interface manager and proxies for both user interface consumers and providers that handle the communication between the computing environments for the user interfaces and the associated backend data across the different computing environments.

Applications may be classified as user interface (UI) providers or UI consumers, with the UI consumers receiving UI components from the UI providers. These UI consumers and UI providers may be distributed across different computing environments. For example, a UI consumer may operate in a computing environment that runs an application for a website. This UI consumer may retrieve UI components from a UI provider farm that may include a number of different UI providers. The UI providers may provide the UI components at runtime, and these components may be displayed in a user interface at the UI consumer application as part of a seamless display. The fact that various UI components may be collected from different computing environments for runtime display may be entirely transparent to a user.

The UI components may remain linked to the underlying data with which they are configured to interface. This allows UI component designers to tightly integrate the UI displays with the underlying data types, thereby linking data and the corresponding data display component together. When the UI component operating as part of an interface in another computing environment needs to display the underlying data from the associated backend, the UI component may send request back to its originating computing environment to the backend interface. This request may be sent through proxies both at the UI consumer and the UI provider. Gateways may be used to facilitate these interactions and to protect each individual computing environment. Some embodiments may also use token services that reside in each of the computing environments to authenticate requests and allow UI consumers and providers to register with each other. Thus, the UI consumer may display real-time data from a backend in a separate computing environment using the corresponding UI component with requests that are securely serviced at runtime.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates an example of a user interface for an application that is composed of a number of different UI tiles, according to some embodiments.

FIG. 2 illustrates a simplified block diagram of a plurality of computing environments that provide different UI tiles for a user interface, according to some embodiments.

FIG. 3 illustrates a diagram of a system that uses provider and consumer proxies for communication, according to some embodiments.

FIG. 4 illustrates a flowchart of a method for operating a user interface with components from multiple computing environments, according to some embodiments.

FIG. 5 illustrates a simplified block diagram of a distributed system for implementing some of the embodiments.

FIG. 6 illustrates a simplified block diagram of components of a system environment by which services provided by the components of an embodiment system may be offered as cloud services.

FIG. 7 illustrates an exemplary computer system, in which various embodiments may be implemented.

### DETAILED DESCRIPTION

Most modern computer applications provide a graphical user interface (GUI) in order to accept user inputs and provide data outputs in an intuitive, well-understood framework that facilitates an efficient and familiar user experience. Applications that provide user interfaces may conceptually be divided into a number of different parts during the design phase. These parts may include what is referred to herein as a “backend,” which in a general sense includes all of the systems that store and retrieve data, process data, execute algorithms and other functions, and/or interact with other systems. The application may also include the user interface itself with which users will interact, and which provides a look-and-feel for the application. The user interface may be configured to receive data from the user; provide that data to the backend where the data may be stored, processed, transmitted, and so forth; and display data retrieved from the backend for the user.

Much time and effort is devoted to effectively displaying data in the user interface. Special graphs, charts, controls, and/or other user interface components may be specifically designed to interact with and display a particular type of data. The best and most effective user interfaces are often tightly coupled to the underlying data provided by the backend. During the design phase of the application, it is desirable for the user interface team to work very closely with the backend team such that the user interface is specifically designed for its backend data. In an ideal situation, user interface designers should possess an intimate knowledge of the data provided by the backend, the operations performed by the backend, the security and authentication schemes used by the backend, and/or other characteristics of the backend in order to present the data to the user in the most effective manner.

However, a technical problem exists in this area of software design. Specifically, user interfaces (UIs) are often designed as monolithic aspects of an application. Although the user interface may include a number of subcomponents, those components are often all designed by a unified team as a single software project that is often not tightly connected with the backend data operations. Alternatively, user interface components may be designed separately by different teams and later combined in top-level user interface for the application. However, while this allows the UI design team to be more familiar with the backend data operations, this leads to fragmented user interface designs that often compromise security, authentication, and communication when combined in the UI of the application. This also often leads to a duplication of effort between design teams, as different applications or components often interact with the same backend data. For example, a database that manages contact information may be used for an application that manages contacts, as well as for another application that uses that same contact data as one aspect of lead management.

These problems become exacerbated as both data storage and data processing become more fragmented and distributed. Specifically, backend systems may be distributed between separate computing environments, such as different cloud providers. No existing solutions allow for the simultaneous display of data from different cloud providers while still enforcing security and authentication protocols for a specific user. More generally, no efficient, secure, and seamless solutions currently exist for unifying data retrieved from backend systems in different computing environments in a unified user interface.

The embodiments described herein solve these and other technical problems by presenting a framework that allows user interface components with their backend services and data to be reused while maintaining an ideal level of security, authentication, and communication. Instead of building a user interface as a microservice for a specific application, this framework allows user interface components to be designed specifically for the associated backend data. These components may then be reused across a number of different applications that all access the same backend data. This framework includes a user interface manager and proxies for both user interface consumers and providers that handle the communication between the computing environments for the user interfaces and the associated backend data across the different computing environments.

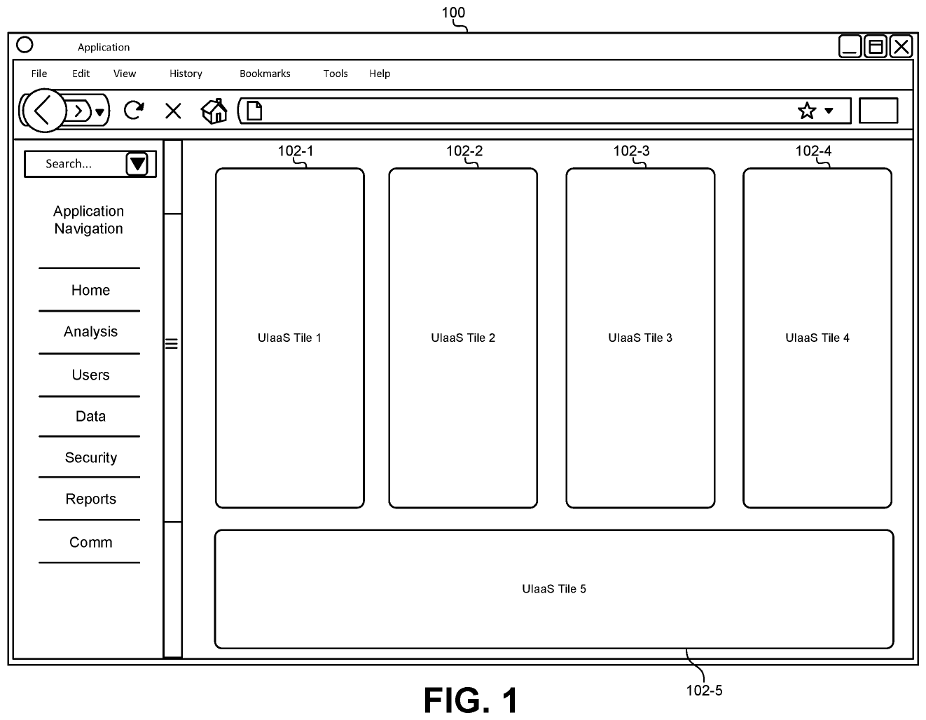

FIG. 1 illustrates an example of a user interface 100 for an application that is composed of a number of different UI tiles, according to some embodiments. In this example, the user interface 100 may include an application that retrieves and displays data from a number of different backend systems that are distributed across different computing environments. The user interface 100 may be configured to provide a unified display of the data from these different backend environments in a way that appears seamless to the user. Specifically, the user interface 100 may include a plurality of UI tiles 102 that are arranged and displayed together in the user interface 100. At the user-experience level, the UI tiles 102 may appear to be a seamless, unified part of the user interface 100. However, the UI framework may in actuality retrieve each of the plurality of UI tiles 102 from different computing environments and handle data transmissions between the UI tiles 102 and the associated backends in the different computing environments. This allows data from a plurality of different computing environments to be displayed in a unified presentation for the user without the user being aware that the UI tiles 102 and the associated data are actually drawn from different computing environments.

As used herein, the term “UI component” may be used interchangeably with the terms “UI tile” or simply “tile.” A tile may comprise a visual tile in the user interface 100 that receives data inputs and/or provides data outputs. For example, a UI tile 102-1 may include a specialized graph for displaying a particular metric. Another UI tile 102-3 may include data entry fields for receiving new contact information and/or output fields for providing existing contact information. Another UI tile 102-3 may include an interactive 3D display of a virtual environment for exploring different data values. As described in detail below, each of these UI tiles 102 may retrieve and/or display information from different corresponding backends that are hosted on different computing environments, such as different cloud systems.

Each of these UI tiles 102 may be designed according to standards that allow the UI tiles 102 to communicate within the application. In some implementations the UI tiles 102 may communicate with each other using events and event handlers/listeners. For example, the UI tile 102-4 may generate an event that is detected by the UI tile 102-5 using an event listener. In this manner data may be passed back and forth between the UI tiles 102. This communication between the UI tiles 102 may take place in addition to the communication between the UI tiles 102 and their associated backends in different computing environments as described below.

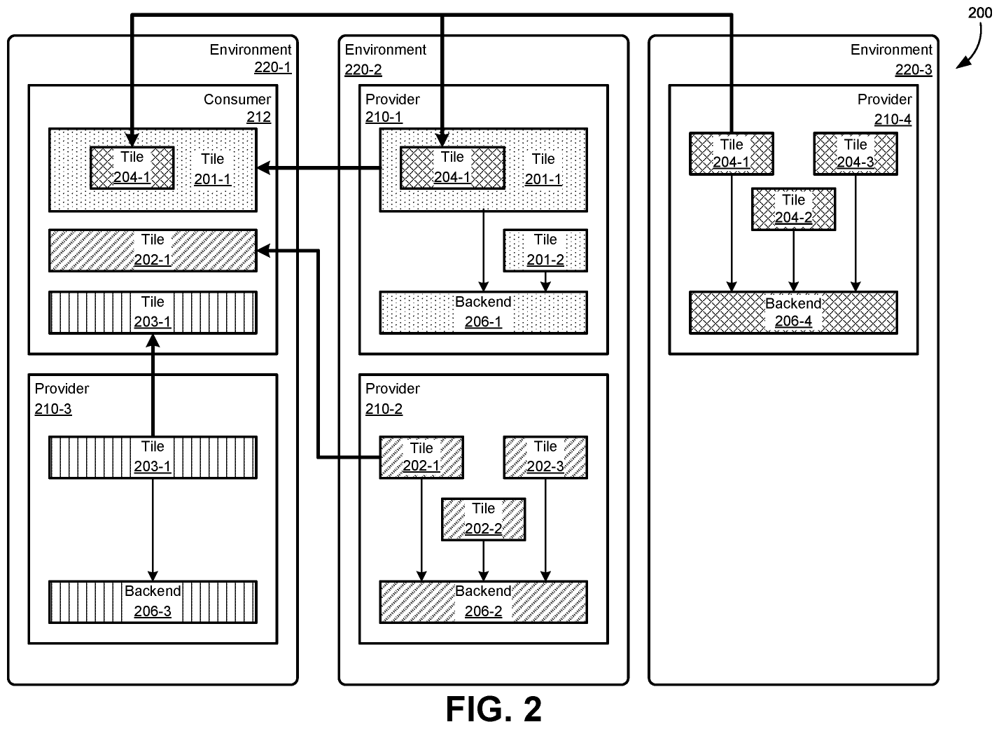

FIG. 2 illustrates a simplified block diagram 200 of a plurality of computing environments 220 that provide different UI tiles for a user interface, according to some embodiments. The different computing environments may be defined as being separate and distinct computing systems. For example, the different computing environments 220 may use separate and distinct operating systems, computer hardware, and instances of applications. The different computing environments 220 may also be distinguished by physical separation. For example, the different computing environments 220 may be hosted by separate and distinct data centers that are separated by, for example, more than 1 mile. The different computing environments 220 may be defined as separate and distinct cloud service providers. For example, the computing environment 220-1 may be hosted by Amazon Web Services®, the computing environment 220-2 may be hosted by Oracle®, and the computing environment 220-3 may be hosted by Microsoft®.

The different entities in this example may be referred to functionally as either consumers or providers. The consumer 212 may host an application with the user interface that imports UI tiles from one or more providers 210. For example, the system may collectively operate as a User Interface as a Service (UIaaS) where the providers 210 provide UI tiles and their corresponding data backends as a service to the UI consumer 212.

In some embodiments, the consumer 212 may comprise an application. The application may include a container in a frontend architecture that is the entry point for the user interface that includes user interface components that are sourced by the consumer 220, along with any user interface components that are provided from the providers 210. Any local UI components from the application of the consumer 212 may be added to the main user interface during a build process for the application. However, UI components from the different providers 210 may be added to the main user interface at runtime with the help of user interface manager, which is described in greater detail below.

The application for the UI consumer 212 may use a configuration that stores information. For example, the configuration may store a list of Universal Resource Locators (URLs) for the proxies for each of the providers 210 that will be used by the application. Optionally, the configuration may also store a URL to a UI token service that may be used to request and renew user tokens if user authorization is implemented by the UIaaS framework. This configuration may be used to initialize a number of resources for the application, such as a shared JavaScript library and/or the UI manager that is responsible for loading and/or injecting the referenced UI components from the different providers 210. More generally, the application may provide a unifying interface between the different providers 210 and may act as the main application providing support for the core functionality in the UIaaS architecture, including routing, navigation, user authorization, user onboarding, and so forth.

The UI providers 210 may provide a set of related UI components together with their corresponding backends. A UI component and a corresponding backend may be grouped together when they fall under the same business domain, which may facilitate a common development team providing both the UI component and the corresponding backend. When incorporated into another application, the web components from the providers 210 may be used as services by other providers 210 and/or a consumer 212. These UI components may be embedded into the Document Object Model (DOM) of the providers 210 and/or consumer 212. The providers 210 and their corresponding UI components may be completely independent from each other and from the consumer 212. For example, UI components may follow completely separate release cycles from the consumer 212 or any other the providers 210. However, when integrated into the application of the consumer 212, the UI components may communicate through the DOM of the application using helper parameters, callback functions, events, and so forth. As described in greater detail below, the providers 210 may implement user authorization with a token service where the UI components of the providers 210 can provide a correct user token to the associated backend, which may then in turn determine whether the user signature is valid and use the permissions for the user in the signed user token to validate access to the data.

In the example of FIG. 2, the application being run by the consumer 212 may include a plurality of UI tiles 201-1, 202-1, 203-1, 204-1. These UI tiles 201-1, 202-1, 203-1, 204-1 may each be retrieved from different UI providers 210 in the UIaaS framework. For example, the provider 210-3 may source a UI tile 203-1 having a corresponding backend 206-3. The UI tile 203-1 may be specifically designed to present and/or interface with the data stored in the corresponding backend 206-3. The backend 206-3 may include databases, database management systems, compute nodes, communication interfaces, and/or any other computing element that may be configured to handle the data presented by the UI tile 203-1. At runtime of the application on the consumer 212, the UI manager of the computing environment 220-1 may retrieve the UI tile 203-1 from the provider 210-3 and visually incorporate the UI tile 203-1 into the UI of the application. During runtime, the UI tile 203-1 may make data requests to the corresponding backend 206-3 to update a data visualization in the UI tile 203-1. The operations for requesting data at runtime and verifying user authorization is described in greater detail below. This illustrates an example of sending a request for data associated with a UI component executing in a first computing environment to a backend in a second computing environment from which the UI component was received, and receiving the data associated with that UI component from the backend.

The providers 210 may act as a source for many different types of UI tiles. For example, the provider 210-2 may provide a plurality of tiles 202 that are each associated with data that is processed and/or stored by the backend 206-2. The tiles 202 may provide different visualizations for the data in the backend 206-2 or may otherwise provide different operations associated with the data. In this example, the application of the consumer 212 may request a tile 202-1 that is incorporated into the live application. Although not illustrated explicitly in FIG. 2, any of the UI tiles 202 may be simultaneously provided to other applications operating in other computing environments. Furthermore, the tile 202-1 provided to the application of the consumer 212 may also be provided to other applications operating in other computing environments. Thus, the UIs provided as a service to different consumers may provide simultaneous and large-scale access to the backend 206-2.

Some entities may act as both consumers and providers, possibly at the same time. For example, provider 210-1 may act as a provider for the consumer 212 while also acting as a consumer for the provider 210-4. A tile 201-1 in the provider 210-1 may act as a consumer for a tile 204-1 from the provider 210-4. (E.g., an element of the user interface component may encapsulate another element from the provider 210-4.) The tile 204-1 may be used in an application that is operated by the provider 210-1. Alternatively or additionally, the tile 204-1 may also act as a subcomponent in the UI component represented by tile 201-1. In some embodiments, the application of the consumer 212 may request the tile 201-1 from the provider 210-1, along with the tile 204-1 from the provider 210-4. In other embodiments, requesting the tile 201-1 from the provider 210-1 may include the tile 204-1 from the provider 210-4. As described above, any of the tiles 204 from the provider 210-4 may also be provided to the consumer 212 and/or to other applications in the UIaaS framework.

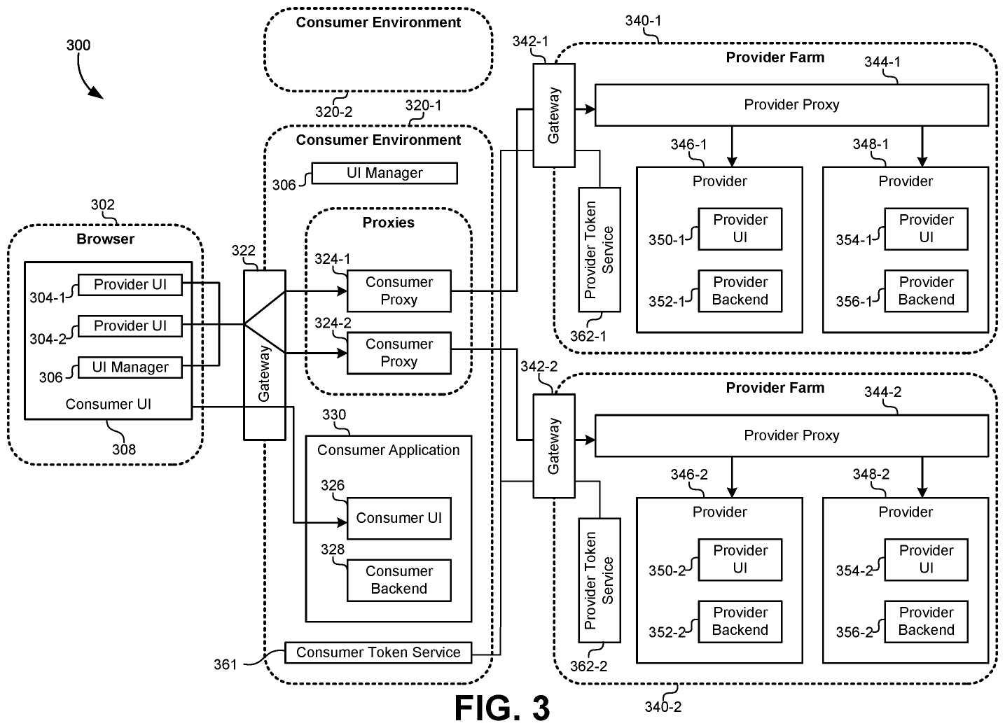

FIG. 3 illustrates a diagram of a system 300 that uses provider and consumer proxies for communication, according to some embodiments. As described above, each of the components for an application 330 may be deployed to multiple computing environments, each having its own network environment. The diagram of the system 300 illustrates these divisions between the computing environments. First, a client browser 302 may include a web browser or other app/application where the user interface is assembled and executed. For example, JavaScript code for the application 330 may be executed in the client browser 302, along with the UI components received from the various providers. Specifically, the browser 302 may execute a UI manager 306, load and execute UI components 308 from the consumer environments 320, and/or load and execute UI components 304 from the providers. Second, the consumer application environments 320 may be where the UI code of the application 330 is deployed and where the backend 328 for the application 330 is operated. Third, the providers may be organized into provider farms 340. The providers 346, 348 may be organized under these provider farms 340 where the UI code 350, 354 and the corresponding backends 352, 356 for the providers 346, 348 are organized.

The UI manager 306 may be implemented as a JavaScript library that may be used by the UI application 326. The UI manager 306 may be a separate software process from the UI application 326. The UI manager 306 may create a configuration cache for all of the registered UI providers by loading UI provider descriptor files. In some embodiments, the UI manager 306 may provide a container web component that can be used by UI consumers or UI providers to dynamically add UI components from the UI provider runtimes. For example, the UI manager 306 may automatically load any needed UI components through the consumer proxies 324 and the provider proxies 344. These loaded UI components can then be dynamically injected into the container web component, and may include information such as a URL to the UI provider service and/or UI through the consumer proxies 324 and the provider proxies 344. As described above, the UI manager 306 may also use a configuration that is used by the UI consumer application 330. When the consumer UI 326 initializes in the browser 308, the configuration may be used to send parameters to the UI manager 306. These parameters may include the list of URLs for the provider proxies that the consumer application 330 may use, and optionally a URL to a token service to request and renew user tokens if user authorization is implemented.

To enable access across the boundaries of these different computing environments, proxies and other networking components may be included in the system 300. In some cases, for the sake of uniformity and extensibility, consumer applications and providers that are deployed in the same computer environment may also communicate through such proxies. A gateway or firewall may be installed to enable external access to the URLs stored in the configuration as described above. In a UIaaS-enabled application, these URLs are transmitted through the gateway 322 in order to download the UI code (HTML, JavaScript, CCS, and other supporting files) from the consumer environments 320 to the browser 302. The gateway 322 allows the code for the UI manager 306 to be downloaded to the browser 302 and allows the browser to access services running on the consumer environment 320-1. The browser 302 typically enforces a security constraint (e.g., CORS) specifying that code downloaded from an environment can only access resources from that same environment. This prevents the UI component 308 from the consumer environment 320-1 from accessing data from any of the provider backends, and vice versa.

The consumer environment 320-1 may include proxies 324 that are used to communicate between the different computing environments. Specifically, the proxies 324 may be used by the consumer environment 320-1 in order to access data in the providers 346, 348. The providers' computing environments may be accessed in order to discover registered providers and their configuration details, to download UI code for UI components hosted by the providers, and to access the providers' backend services. Therefore, the main function of the consumer proxies 324 is to forward requests and provide access and optionally authentication to the provider farms 340.

When forwarding requests from the provider UIs 304 operating as part of the consumer application 330, each of the consumer proxies 324 may be assigned a unique URL in the consumer's environment 320-1. In some embodiments, the consumer proxies 324 may include a plurality of proxies that are each uniquely assigned to specific provider proxies. For example, the consumer proxy 324-1 may be assigned specifically to the provider proxy 344-1. When the consumer proxy 324-1 receives a request from the provider UI 304-1, the consumer proxy 324-1 may parse the URL of the request, remove the prefix that addressed the consumer proxy 324-1, append the remaining URL to the URL of the provider proxy 344-1 and forward the request parameters, cookies, payload, etc., with the request to the provider proxy 344-1.

In some cases, the provider farms 340-1 may require a specific authentication to enable access to the computing environment. The consumer proxy 324-1 may add the additional authentication information to the request to ensure that the provider proxy 344-1 is able to receive the request through the gateway 342-1. In other words, it may be the responsibility of the consumer proxy 324-1 to identify the actual user login and send the identity to the provider proxy 344-1. For example, some embodiments may use SSO to identify the user for a specific request. Alternatively, a token-based user authorization method may be used as described below.

The main function of the provider proxies 344 is to receive requests from the consumer proxies 324 and forward these requests to the requested UI providers 346, 348. Each of the provider proxies 344 may be responsible for all the UI providers 346, 348 in the corresponding provider farm. Therefore, each existing UI provider 346, 348 may be registered with the corresponding provider proxies 344. This registration may provide a unique name or identifier for the provider, a URL to access the provider's configuration, a URL to access the provider's UI, and a URL to the UI provider's backend services.

A provider proxy 344-1 may be called from multiple consumer proxies. The provider proxy 344-1 may maintain a list of consumer proxies as a list of unique identifiers. Each consumer proxy may also maintain a list of available providers that can be accessed from that particular consumer proxy. This allows the infrastructure to control which UI consumers are able to access each UI provider. When receiving a request, the provider proxy 344-1 may verify the unique identifier from the sending consumer proxy 324-1 to verify that the request is authorized. When the request is authorized, the provider proxy 344-1 may parse the request URL to determine whether the request is targeting the provider configuration, the provider UI 350-1, or the provider backend 352-1. The provider proxy 344-1 may then forward the request to the correct destination.

As mentioned briefly above, some embodiments of the UIaaS framework may provide token services for user authorization. For example, some embodiments may issue a user token for a logged on user at the browser 302. The user token may include any permissions for that user. These permissions may be understood by the UI provider and may be used by the UI provider to determine whether the UI provider can return requested data. The permissions of the users may be maintained by the consumer application 330 exclusively. This allows the consumer environment 320-1 to manage the responsibility of determining which permissions should be granted to the user. Once granted, user tokens that encode these permissions may be signed using a provider token service 361 that can be validated in the UI providers.

In order to facilitate this infrastructure, the consumer token service 361 may contact each of the UI provider token services 362 that may be used by the consumer application 330. The UI provider token services 362 returns signed tokens to the consumer token service 361. For example, the consumer token service 361 provides a key or identifier to identify the consumer environment 320-1 along with a list of permissions the given consumer environment 320-1 may need to obtain for its users. The consumer token service 361 may be integrated with a specific user authorization scheme for the consumer application 330. The consumer token service 361 may create signed tokens that represent user permissions and provide those tokens to the UI manager 306. The consumer token service 361 may then store in the configuration all of the UI provider token services 362 that may be called.

To authenticate a user, the UI consumer token service 361 may identify a logged on user using the authentication method of the consumer application 330. Thus, the consumer token service 361 may access the authorization method of the consumer application 330 in order to obtain the user permissions for each of the UI provider token services 362. The Consumer Token Service 361 may invoke each of the UI provider token services 362 in its configuration file and request a signed token for the user with the associated permissions. The consumer token service 361 may then package all of the received user tokens and return them as a single consolidated response to the UI manager 306 in the browser 302.

The provider token services 362 may be part of the computing environments of the corresponding UI providers. The provider token services 362 may sign tokens with a key that is trusted by the providers in each computing environment. The provider token services 362 may also restrict which permissions each UI consumer can request for its users. For example, the provider token services 362 may receive a request for a user token. The request includes a consumer identifier, a username and a list of permissions being requested. If the list of permissions requested are all part of an approved set of permissions for the consumer (e.g., a contract) then the UI provider token services 362 may issue a signed user token for the user with the requested permissions. Note that the provider token services 362 do not need to know any specific information about the user, but may instead trust the consumer token service 361 that the user should be given the requested permissions, if those permissions are allowed by the provider. For example, the consumer token service 361 may know which user can have which permission. The provider token service 362 need not know which user can have which permission, but may only know which consumer can have which permission The provider token service 362 may only sign the permission request if those permissions are approved for the requesting consumer.

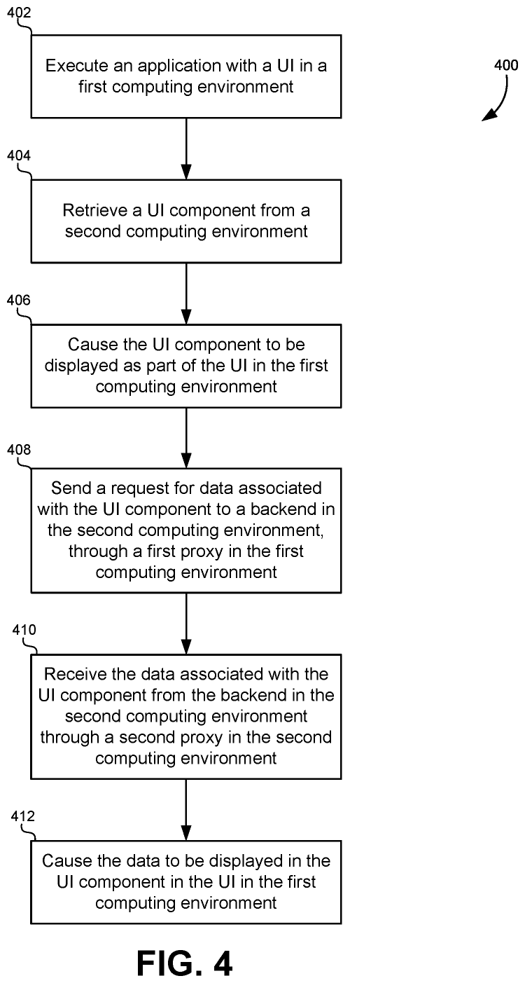

FIG. 4 illustrates a flowchart 400 of a method for operating a user interface with components from multiple computing environments, according to some embodiments. The method may include executing an application in a first computing environment (402). The application may include a UI. For example, the first computing environment may include the consumer environment 320-1 illustrated above in FIG. 3 and/or the first computing environment 220-1 in FIG. 2. A user may load the consumer UI application 326 into the browser 302 by accessing the main URL of the application. The consumer UI application 326 may access the consumer backend 328 as needed. This may involve loading UI components into the user interface from the consumer backend 328 as part of initializing the application.

The method may additionally include retrieving a UI component from a second computing environment (404). The consumer application 330 may initialize a JavaScript library for the UI manager 306. The UI manager 306 may request the UI descriptor from all the UI providers to create a cache of the UI provider configurations. This request may pass through the UI consumer and provider proxies described above. Responses from the UI providers may be used to generate a list of UI providers for the UI manager 306. In some environments, this may create a cache of UI provider configurations.

The method may further include causing the UI component to be displayed as part of the UI in the first computing environment (406). For example, the UI manager 306 may load the common web components from registered UI providers received through the consumer/provider proxies. The UI manager 306 may then cause the UI component from the second computing environment (along with UI components from other computing environments) to be displayed together with any UI components from the first computing environment. The UI manager 306 may load all the UI components needed to build the current page in the browser. In some configurations, this may be a recursive process where one web component may reference another web component as illustrated in FIG. 2. Loading these components may be performed through the UI proxies. The UI manager 306 may then inject the loaded web components into the main application UI dynamically at runtime.

The method may further include sending a request for data associated with the UI component to a backend in the second computing environment (408). The web components loaded from the UI providers may call their own backend services as needed. These requests may pass through the first proxy in the first computing environment, such as the consumer proxies in FIG. 3. This request may be handled by a second proxy in the second computing environment, such as the provider proxies described above. This request process may include using a UI consumer token service and/or a UI provider token service to pass signed user tokens between the computing environments. The provider token service may check its corresponding configuration to determine whether the agreement with the particular UI consumer includes the requested permissions. When the UI component calls its corresponding backend in the second computing environment, it may use an API from the UI manager 360 retrieve the user token for the provider token service. This user token may then be passed with the request to authenticate and authorize the user and provide permissions to access the requested data. The UI consumer/provider proxies may also resolve any cross-domain communication differences. For example, the UI component itself may include any JavaScript or code needed to make the request to the backend. Therefore, the overall UI and consumer application do not need to know any of the details of how this communication takes place or how the data will be requested, since this request is handled from the UI component itself to the second computing environment.

The method may also include receiving the data associated with the UI component from the backend in the second computing environment (410). The response may be sent through the second proxy in the second computing environment, such as the provider proxy. The data may be received through the consumer proxies in the first computing environment, and the first computing environment may cause the data associated with the UI component to be displayed in the UI component in the overall UI for the application (412). For example, this data may be used to populate a graph or other data visualization in the UI component.

It should be appreciated that the specific steps illustrated in FIG. 4 provide particular methods of operating a user interface with components from multiple computing environments according to various embodiments. Other sequences of steps may also be performed according to alternative embodiments. For example, alternative embodiments may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

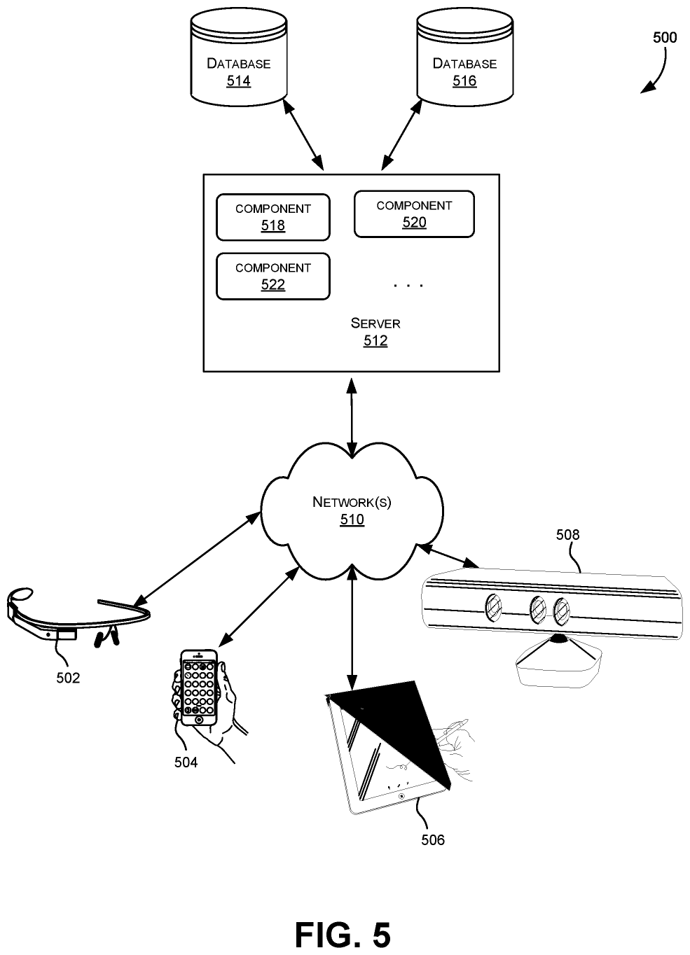

FIG. 5 depicts a simplified diagram of a distributed system 500 for implementing one of the embodiments. In the illustrated embodiment, distributed system 500 includes one or more client computing devices 502, 504, 506, and 508, which are configured to execute and operate a client application such as a web browser, proprietary client (e.g., Oracle Forms), or the like over one or more network(s) 510. Server 512 may be communicatively coupled with remote client computing devices 502, 504, 506, and 508 via network 510.

In various embodiments, server 512 may be adapted to run one or more services or software applications provided by one or more of the components of the system. In some embodiments, these services may be offered as web-based or cloud services or under a Software as a Service (SaaS) model to the users of client computing devices 502, 504, 506, and/or 508. Users operating client computing devices 502, 504, 506, and/or 508 may in turn utilize one or more client applications to interact with server 512 to utilize the services provided by these components.

In the configuration depicted in the figure, the software components 518, 520 and 522 of system 500 are shown as being implemented on server 512. In other embodiments, one or more of the components of system 500 and/or the services provided by these components may also be implemented by one or more of the client computing devices 502, 504, 506, and/or 508. Users operating the client computing devices may then utilize one or more client applications to use the services provided by these components. These components may be implemented in hardware, firmware, software, or combinations thereof. It should be appreciated that various different system configurations are possible, which may be different from distributed system 500. The embodiment shown in the figure is thus one example of a distributed system for implementing an embodiment system and is not intended to be limiting.

Client computing devices 502, 504, 506, and/or 508 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 502, 504, 506, and 508 may be any other electronic device, such as a thin-client computer, an Internet-enabled gaming system (e.g., a Microsoft Xbox gaming console with or without a Kinect® gesture input device), and/or a personal messaging device, capable of communicating over network(s) 510.

Although exemplary distributed system 500 is shown with four client computing devices, any number of client computing devices may be supported. Other devices, such as devices with sensors, etc., may interact with server 512.

Network(s) 510 in distributed system 500 may be any type of network that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 510 can be a local area network (LAN), such as one based on Ethernet, Token-Ring and/or the like. Network(s) 510 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 512 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 512 may be adapted to run one or more services or software applications described in the foregoing disclosure. For example, server 512 may correspond to a server for performing processing described above according to an embodiment of the present disclosure.

Server 512 may run an operating system including any of those discussed above, as well as any commercially available server operating system. Server 512 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 512 may include one or more applications to analyze and consolidate data feeds and/or event updates received from users of client computing devices 502, 504, 506, and 508. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 512 may also include one or more applications to display the data feeds and/or real-time events via one or more display devices of client computing devices 502, 504, 506, and 508.

Distributed system 500 may also include one or more databases 514 and 516. Databases 514 and 516 may reside in a variety of locations. By way of example, one or more of databases 514 and 516 may reside on a non-transitory storage medium local to (and/or resident in) server 512. Alternatively, databases 514 and 516 may be remote from server 512 and in communication with server 512 via a network-based or dedicated connection. In one set of embodiments, databases 514 and 516 may reside in a storage-area network (SAN). Similarly, any necessary files for performing the functions attributed to server 512 may be stored locally on server 512 and/or remotely, as appropriate. In one set of embodiments, databases 514 and 516 may include relational databases, such as databases provided by Oracle, that are adapted to store, update, and retrieve data in response to SQL-formatted commands.

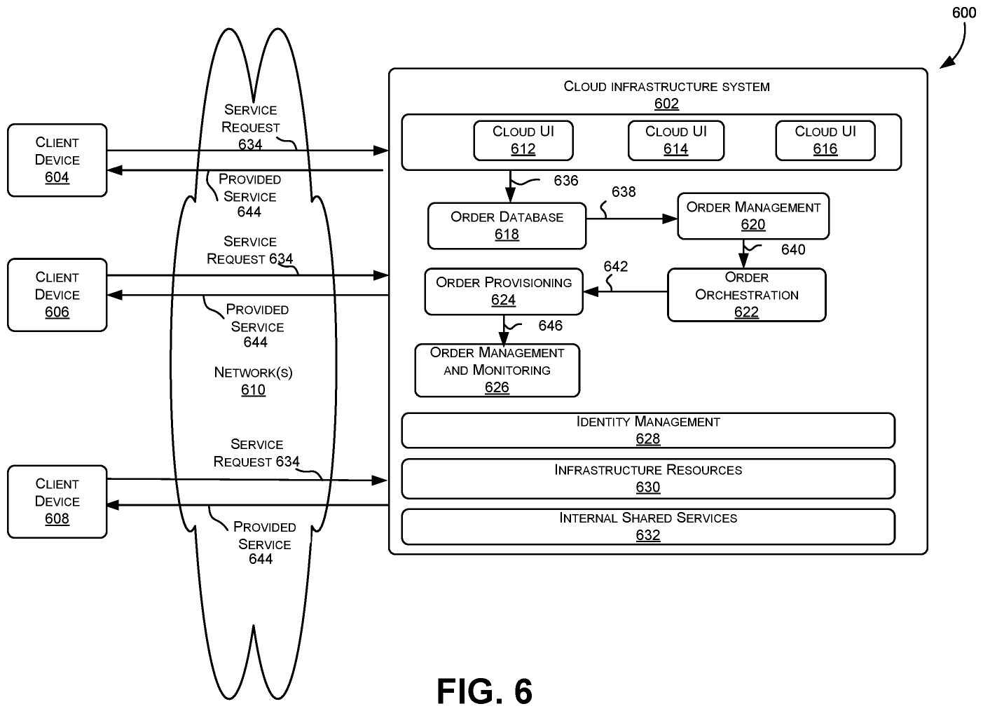

FIG. 6 is a simplified block diagram of one or more components of a system environment 600 by which services provided by one or more components of an embodiment system may be offered as cloud services, in accordance with an embodiment of the present disclosure. In the illustrated embodiment, system environment 600 includes one or more client computing devices 604, 606, and 608 that may be used by users to interact with a cloud infrastructure system 602 that provides cloud services. The client computing devices may be configured to operate a client application such as a web browser, a proprietary client application (e.g., Oracle Forms), or some other application, which may be used by a user of the client computing device to interact with cloud infrastructure system 602 to use services provided by cloud infrastructure system 602.

It should be appreciated that cloud infrastructure system 602 depicted in the figure may have other components than those depicted. Further, the system shown in the figure is only one example of a cloud infrastructure system that may incorporate some embodiments. In some other embodiments, cloud infrastructure system 602 may have more or fewer components than shown in the figure, may combine two or more components, or may have a different configuration or arrangement of components.

Client computing devices 604, 606, and 608 may be devices similar to those described above for 502, 504, 506, and 508.

Although exemplary system environment 600 is shown with three client computing devices, any number of client computing devices may be supported. Other devices such as devices with sensors, etc. may interact with cloud infrastructure system 602.

Network(s) 610 may facilitate communications and exchange of data between clients 604, 606, and 608 and cloud infrastructure system 602. Each network may be any type of network that can support data communications using any of a variety of commercially-available protocols, including those described above for network(s) 510.

Cloud infrastructure system 602 may comprise one or more computers and/or servers that may include those described above for server 512.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 602 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 602 may be adapted to automatically provision, manage and track a customer's subscription to services offered by cloud infrastructure system 602. Cloud infrastructure system 602 may provide the cloud services via different deployment models. For example, services may be provided under a public cloud model in which cloud infrastructure system 602 is owned by an organization selling cloud services (e.g., owned by Oracle) and the services are made available to the general public or different industry enterprises. As another example, services may be provided under a private cloud model in which cloud infrastructure system 602 is operated solely for a single organization and may provide services for one or more entities within the organization. The cloud services may also be provided under a community cloud model in which cloud infrastructure system 602 and the services provided by cloud infrastructure system 602 are shared by several organizations in a related community. The cloud services may also be provided under a hybrid cloud model, which is a combination of two or more different models.

In some embodiments, the services provided by cloud infrastructure system 602 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 602. Cloud infrastructure system 602 then performs processing to provide the services in the customer's subscription order.

In some embodiments, the services provided by cloud infrastructure system 602 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 602 may also include infrastructure resources 630 for providing the resources used to provide various services to customers of the cloud infrastructure system. In one embodiment, infrastructure resources 630 may include pre-integrated and optimized combinations of hardware, such as servers, storage, and networking resources to execute the services provided by the PaaS platform and the SaaS platform.

In some embodiments, resources in cloud infrastructure system 602 may be shared by multiple users and dynamically re-allocated per demand. Additionally, resources may be allocated to users in different time zones. For example, cloud infrastructure system 630 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 632 may be provided that are shared by different components or modules of cloud infrastructure system 602 and by the services provided by cloud infrastructure system 602. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 602 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 602, and the like.

In one embodiment, as depicted in the figure, cloud management functionality may be provided by one or more modules, such as an order management module 620, an order orchestration module 622, an order provisioning module 624, an order management and monitoring module 626, and an identity management module 628. These modules may include or be provided using one or more computers and/or servers, which may be general purpose computers, specialized server computers, server farms, server clusters, or any other appropriate arrangement and/or combination.

In exemplary operation 634, a customer using a client device, such as client device 604, 606 or 608, may interact with cloud infrastructure system 602 by requesting one or more services provided by cloud infrastructure system 602 and placing an order for a subscription for one or more services offered by cloud infrastructure system 602. In certain embodiments, the customer may access a cloud User Interface (UI), cloud UI 612, cloud UI 614 and/or cloud UI 616 and place a subscription order via these UIs. The order information received by cloud infrastructure system 602 in response to the customer placing an order may include information identifying the customer and one or more services offered by the cloud infrastructure system 602 that the customer intends to subscribe to.

After an order has been placed by the customer, the order information is received via the cloud UIs, 612, 614 and/or 616.

At operation 636, the order is stored in order database 618. Order database 618 can be one of several databases operated by cloud infrastructure system 618 and operated in conjunction with other system elements.

At operation 638, the order information is forwarded to an order management module 620. In some instances, order management module 620 may be configured to perform billing and accounting functions related to the order, such as verifying the order, and upon verification, booking the order.

At operation 640, information regarding the order is communicated to an order orchestration module 622. Order orchestration module 622 may utilize the order information to orchestrate the provisioning of services and resources for the order placed by the customer. In some instances, order orchestration module 622 may orchestrate the provisioning of resources to support the subscribed services using the services of order provisioning module 624.

In certain embodiments, order orchestration module 622 enables the management of business processes associated with each order and applies business logic to determine whether an order should proceed to provisioning. At operation 642, upon receiving an order for a new subscription, order orchestration module 622 sends a request to order provisioning module 624 to allocate resources and configure those resources needed to fulfill the subscription order. Order provisioning module 624 enables the allocation of resources for the services ordered by the customer. Order provisioning module 624 provides a level of abstraction between the cloud services provided by cloud infrastructure system 600 and the physical implementation layer that is used to provision the resources for providing the requested services. Order orchestration module 622 may thus be isolated from implementation details, such as whether or not services and resources are actually provisioned on the fly or pre-provisioned and only allocated/assigned upon request.

At operation 644, once the services and resources are provisioned, a notification of the provided service may be sent to customers on client devices 604, 606 and/or 608 by order provisioning module 624 of cloud infrastructure system 602.

At operation 646, the customer's subscription order may be managed and tracked by an order management and monitoring module 626. In some instances, order management and monitoring module 626 may be configured to collect usage statistics for the services in the subscription order, such as the amount of storage used, the amount data transferred, the number of users, and the amount of system up time and system down time.

In certain embodiments, cloud infrastructure system 600 may include an identity management module 628. Identity management module 628 may be configured to provide identity services, such as access management and authorization services in cloud infrastructure system 600. In some embodiments, identity management module 628 may control information about customers who wish to utilize the services provided by cloud infrastructure system 602. Such information can include information that authenticates the identities of such customers and information that describes which actions those customers are authorized to perform relative to various system resources (e.g., files, directories, applications, communication ports, memory segments, etc.) Identity management module 628 may also include the management of descriptive information about each customer and about how and by whom that descriptive information can be accessed and modified.

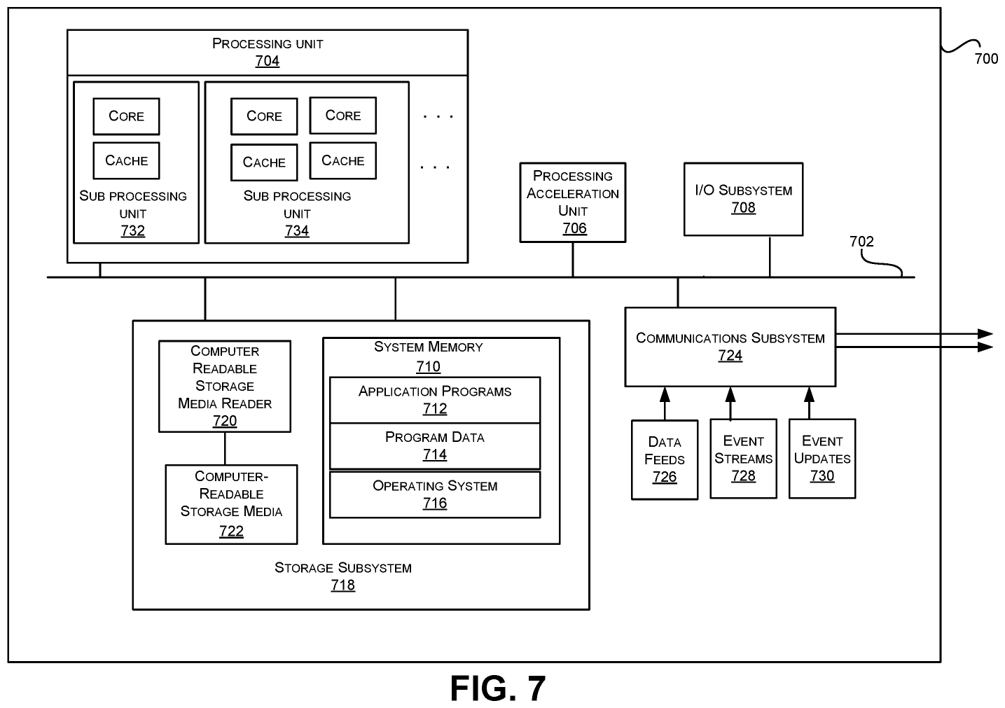

FIG. 7 illustrates an exemplary computer system 700, in which various embodiments may be implemented. The system 700 may be used to implement any of the computer systems described above. As shown in the figure, computer system 700 includes a processing unit 704 that communicates with a number of peripheral subsystems via a bus subsystem 702. These peripheral subsystems may include a processing acceleration unit 706, an I/O subsystem 708, a storage subsystem 718 and a communications subsystem 724. Storage subsystem 718 includes tangible computer-readable storage media 722 and a system memory 710.

Bus subsystem 702 provides a mechanism for letting the various components and subsystems of computer system 700 communicate with each other as intended. Although bus subsystem 702 is shown schematically as a single bus, alternative embodiments of the bus subsystem may utilize multiple buses. Bus subsystem 702 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 704, which can be implemented as one or more integrated circuits (e.g., a conventional microprocessor or microcontroller), controls the operation of computer system 700. One or more processors may be included in processing unit 704. These processors may include single core or multicore processors. In certain embodiments, processing unit 704 may be implemented as one or more independent processing units 732 and/or 734 with single or multicore processors included in each processing unit. In other embodiments, processing unit 704 may also be implemented as a quad-core processing unit formed by integrating two dual-core processors into a single chip.

In various embodiments, processing unit 704 can execute a variety of programs in response to program code and can maintain multiple concurrently executing programs or processes. At any given time, some or all of the program code to be executed can be resident in processor(s) 704 and/or in storage subsystem 718. Through suitable programming, processor(s) 704 can provide various functionalities described above. Computer system 700 may additionally include a processing acceleration unit 706, which can include a digital signal processor (DSP), a special-purpose processor, and/or the like.

I/O subsystem 708 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 700 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 700 may comprise a storage subsystem 718 that comprises software elements, shown as being currently located within a system memory 710. System memory 710 may store program instructions that are loadable and executable on processing unit 704, as well as data generated during the execution of these programs.

Depending on the configuration and type of computer system 700, system memory 710 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 704. In some implementations, system memory 710 may include multiple different types of memory, such as static random access memory (SRAM) or dynamic random access memory (DRAM). In some implementations, a basic input/output system (BIOS), containing the basic routines that help to transfer information between elements within computer system 700, such as during start-up, may typically be stored in the ROM. By way of example, and not limitation, system memory 710 also illustrates application programs 712, which may include client applications, Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 718 may also provide a tangible computer-readable storage medium for storing the basic programming and data constructs that provide the functionality of some embodiments. Software (programs, code modules, instructions) that when executed by a processor provide the functionality described above may be stored in storage subsystem 718. These software modules or instructions may be executed by processing unit 704. Storage subsystem 718 may also provide a repository for storing data used in accordance with some embodiments.

Storage subsystem 700 may also include a computer-readable storage media reader 720 that can further be connected to computer-readable storage media 722. Together and, optionally, in combination with system memory 710, computer-readable storage media 722 may comprehensively represent remote, local, fixed, and/or removable storage devices plus storage media for temporarily and/or more permanently containing, storing, transmitting, and retrieving computer-readable information.

Computer-readable storage media 722 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 700.

By way of example, computer-readable storage media 722 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to connect to one or more devices via the Internet. In some embodiments communications subsystem 724 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 724 can provide wired network connectivity (e.g., Ethernet) in addition to or instead of a wireless interface.

In some embodiments, communications subsystem 724 may also receive input communication in the form of structured and/or unstructured data feeds 726, event streams 728, event updates 730, and the like on behalf of one or more users who may use computer system 700.

By way of example, communications subsystem 724 may be configured to receive data feeds 726 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 724 may also be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 724 may also be configured to output the structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A non-transitory computer-readable medium comprising instructions that, when executed by one or more processors, cause the one or more processors to perform operations comprising:
executing an application in a first computing environment, wherein the application comprises a user interface (UI);
retrieving a UI component from a second computing environment;
causing the UI component to be displayed as part of the UI in the first computing environment;
sending, from the UI component, a request for data associated with the UI component to a backend in the second computing environment, wherein the request is sent through a first proxy in the first computing environment;
receiving, by the UI component, the data associated with the UI component from the backend in the second computing environment, wherein the data is sent through a second proxy in the second computing environment; and
causing the data associated with the UI component to be displayed in the UI component in the UI in the first computing environment.

2. The non-transitory computer-readable medium of claim 1, wherein the UI component is displayable in the application in the first computing environment while the UI component is also deployed and running in another application in another computing environment transparently to the user.

3. The non-transitory computer-readable medium of claim 1, wherein a single deployment, comprising a single instance or multiple instances of the UI component, is added to multiple applications.

4. The non-transitory computer-readable medium of claim 1, wherein:
the user interface for the application further comprises a local UI component from the first computing environment that is loaded during a build process for the application, and
the UI component from the second computing environment is loaded into the application at runtime by a user interface manager.

5. The non-transitory computer-readable medium of claim 1, wherein the application in the first computing environment is a UI consumer in a User Interface as a Service (UIaaS) framework, and the backend in the second computing environment comprises a UI provider in the UIaaS framework.

6. The non-transitory computer-readable medium of claim 1, wherein the operations further comprise:
accessing a configuration that stores Universal Resource Locators (URLs) for proxies that provide UI components for the application, wherein the configuration comprises a URL for the second proxy in the second computing environment.

7. The non-transitory computer-readable medium of claim 6, wherein the configuration is accessed by a UI manager that is separate from the application, and the UI manager generates a container in which the UI component is dynamically added from a runtime of the second computing environment.

8. The non-transitory computer-readable medium of claim 1, wherein the UI component is embedded into a Document Object Model (DOM) of the application.

9. The non-transitory computer-readable medium of claim 1, wherein the UI component from the second computing environment is also provided to a second application executing in a third computing environment, wherein the application from the first computing environment and the second application from the third computing environment both access the data associated with the UI component from the backend in the second computing environment.

10. The non-transitory computer-readable medium of claim 1, wherein the UI component comprises a second UI component embedded in the UI component, wherein the second UI component is retrieved from a third computing environment and accesses data at a corresponding backend in the third computing environment, and the UI component and the second UI component are both displayed as part of the UI of the application in the first computing environment.

11. The non-transitory computer-readable medium of claim 1, wherein the second computing environment provides a plurality of UI components to different applications that access the backend in the second computing environment.

12. The non-transitory computer-readable medium of claim 1, wherein the second computing environment comprises a provider farm that organizes a plurality of different UI providers.

13. The non-transitory computer-readable medium of claim 1, wherein the first proxy comprises a consumer proxy that is uniquely assigned to send requests to the second proxy comprising a provider proxy, and the first computing environment comprises another consumer proxy that is uniquely assigned to send requests to another provider proxy in a third computing environment.

14. The non-transitory computer-readable medium of claim 1, wherein the operations further comprise:
signing a user token in the first computing environment using a token service of the first computing environment, wherein the token service of the first computing environment uses an authorization method of the application; and
sending the user token to the second proxy in the second computing environment.

15. The non-transitory computer-readable medium of claim 1, wherein the UI component comprises code that generates the request for the data associated with the UI component.

16. The non-transitory computer-readable medium of claim 1, wherein the operations further comprise requesting descriptors from a plurality of UI providers in a plurality of other computing environments during initialization of the application.

17. The non-transitory computer-readable medium of claim 16, wherein the operations further comprise creating a local store of UI provider configurations in the browser, wherein the UI provider configurations are used to load UI components from the other computing environments.

18. The non-transitory computer-readable medium of claim 1, wherein the UI component comprises a data visualization that provides a graph of the data associated with the UI component.

19. A method of operating user interfaces with components from multiple computing environments, the method comprising:
executing an application in a first computing environment, wherein the application comprises a user interface (UI);
retrieving a UI component from a second computing environment;
causing the UI component to be displayed as part of the UI in the first computing environment;
sending a request for data associated with the UI component to a backend in the second computing environment, wherein the request is sent through a first proxy in the first computing environment;
receiving the data associated with the UI component from the backend in the second computing environment, wherein the data is sent through a second proxy in the second computing environment; and
causing the data associated with the UI component to be displayed in the UI component in the UI in the first computing environment.

20. A system comprising:
one or more processors; and
one or more memory devices comprising instructions that, when executed by the one or more processors, cause the one or more processors to perform operations comprising:
executing an application in a first computing environment, wherein the application comprises a user interface (UI);
retrieving a UI component from a second computing environment;
causing the UI component to be displayed as part of the UI in the first computing environment;
sending a request for data associated with the UI component to a backend in the second computing environment, wherein the request is sent through a first proxy in the first computing environment;
receiving the data associated with the UI component from the backend in the second computing environment, wherein the data is sent through a second proxy in the second computing environment; and
causing the data associated with the UI component to be displayed in the UI component in the UI in the first computing environment.
